(19) United States
(12) Patent Application Publication
(10) Pub. No.: US 2025/0384129 A1
(43) Pub. Date: Dec. 18, 2025

(54) SEMI-SUPERVISED MALWARE CLASSIFICATION USING REPRESENTATION-AGNOSTIC TRANSFORMER MODELS

(71) Applicant: CrowdStrike, Inc., Sunnyvale, CA (US)

(72) Inventors: Florian Störtz, London (GB); Felix Schwyzer, Berlin (DE); Marian Radu, Bucharest (RO); Mihaela-Petruta Gaman, Bucuresti (RO)

(21) Appl. No.: 18/900,317

(22) Filed: Sep. 27, 2024

Related U.S. Application Data
(60) Provisional application No. 63/659,968, filed on Jun. 14, 2024.

(51) Int. Cl. G06F 21/56; G06N 20/00

(52) U.S. Cl. CPC G06F 21/56; G06N 20/00; G06F 2221/034

(57) ABSTRACT

A method of monitoring an endpoint for malicious code includes obtaining a corpus of files collected by an endpoint protection system, selecting a subset of the corpus of files comprising labeled files, wherein the subset of the corpus is representative of the corpus of files, and training a first artificial intelligence (AI) model, using the subset of the corpus of files in byte form, to infer labels for unlabeled data. The method further includes applying the first AI model to unlabeled files of the corpus of files in byte form to generate labels for the unlabeled files, performing supervised training of a second AI model using the corpus of files and the labels generated for the unlabeled data, and deploying the second AI model to the endpoint protection system.

### RELATED APPLICATIONS

This application claims benefit of provisional U.S. Patent Application No. 63/659,968 filed on Jun. 14, 2024, which is herein incorporated by reference in its entirety.

### TECHNICAL FIELD

Aspects of the present disclosure relate to detecting injected malware in binary files, and more particularly, semi-supervised malware classification using representation agnostic transformer models.

### BACKGROUND

Binary files are files that have been compiled and are ready for execution by a processor. Binary files are a popular format for malware infections where malware is injected into the binary code such that the malware is executed when the infected file is executed. Detecting malware infected binary files can be done using rule-based systems or models applied on the entire files. Other types of malware may include worms, trojans, ransomware, spyware, adware, fileless malware, etc.

Artificial intelligence (AI) is a field of computer science that encompasses the development of systems capable of performing tasks that typically require human intelligence. Machine learning is a branch of artificial intelligence focused on developing algorithms and models that allow computers to learn from data and make predictions or decisions without being explicitly programmed. Machine learning models are the foundational building blocks of machine learning, representing the mathematical and computational frameworks used to extract patterns and insights from data. Large language models, a specialized category within machine learning models, are trained on vast amounts of text data to capture the nuances of language and context. By combining advanced machine learning techniques with enormous datasets, large language models harness data-driven approaches to achieve highly sophisticated language understanding and generation capabilities. As discussed herein, artificial intelligence models, or AI models, include machine learning models, large language models, and other types of models that are based on neural networks, genetic algorithms, expert systems, Bayesian networks, reinforcement learning, decision trees, or combination thereof.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a block diagram illustrating an example system architecture, in accordance with some embodiments of the present disclosure.

FIG. 2A is a block diagram that illustrates an example system for training a byte-based classification model, in accordance with some embodiments of the present disclosure.

FIG. 2B is a block diagram illustrating an example system for preprocessing executable files for a byte-based classification model, in accordance with some embodiments of the present disclosure.

FIG. 2C is a block diagram illustrating training of an inference pipeline using labels generated via a byte-based classification model, according to embodiments of the present disclosure.

FIG. 3 is a block diagram illustrating an example system for file classification using one or more classification models trained via a labeling output of a byte-based classification model, in accordance with embodiments of the present disclosure.

FIG. 4 is a block diagram illustrating an example computing system for deployment of a classification model via a semi-supervised training approach, in accordance with some embodiments of the present disclosure.

FIG. 5 is a flow diagram of an example method of deploying a classification model via a semi-supervised training approach, in accordance with some embodiments of the present disclosure.

FIG. 6 is a block diagram of an example computing device that may perform one or more of the operations described herein, in accordance with some embodiments of the present disclosure.

### DETAILED DESCRIPTION

Endpoint sensors may gather massive amounts of byte buffer data over time while collecting telemetry data associated with endpoint devices. For example, sensors may collect shell code, dynamic link libraries, portable executables, compiled operating system executable files, and so forth while monitoring an endpoint. The utility of collecting large amounts of data and files from monitored endpoints is limited by the ability to process the data in a useful manner. Conventional systems analyze and classify this type of collected data using rule-based systems, tree-based machine learning models, or in some cases, neural networks, each of which may require supervised training (e.g., labeled data) and thus rely on human judgment for labeling the data points (e.g., separating malicious from benign occurrences). These conventional approaches are labor intensive, making it economically unfeasible to carry out at scale and effectively rendering a large amount of captured telemetry data unusable for model training.

The present disclosure addresses the above-noted and other deficiencies by providing a semi-supervised learning approach with a byte-based AI model as an initial classifier. In some embodiments, an initial classifier (e.g., a byte-based AI model) is trained on labeled data that is a representative subset of the corpus of a set of generally unlabeled data (e.g., collected files or events). Once the initial classifier is trained, the trained classifier is used to generate labels for originally unlabeled data points at scale. Accordingly, insights are generated on unlabeled data without requiring human involvement to label all the data by applying the initial classifier trained on the labeled data to the unlabeled portions of the corpus of data (e.g., corpus of files or events).

In some embodiments, a representation-agnostic modeling approach may be used for the initial classifier. For example, the representation-agnostic model may be a byte-based classification model (e.g., AI model trained on data in raw byte form), such as a transformer-based machine learning model. For example, the initial classification model may be trained on bytes (e.g., files in raw byte form) of labeled data which makes up a small subset of the corpus of files that are to be used for training a final classifier. Byte form of a file may refer to the bytes of the data rather than the actual data represented by the bytes. In other words, the semantic meaning and any encoding or modality of the bytes is disregarded to allow the bytes themselves to be used as training and inference data for a classifier. Accordingly, a machine learning model (e.g., classification model 105A and 205A) may operate directly on the bits or bytes of a file to identify patterns in the bits or bytes themselves. For example, data may be encoded via various different modalities, in different file types, and in different operating systems. Thus, the same data, such as a character, numeral, etc. may be represented by various different combinations of bits or bytes in the different encodings and modalities. Conventionally, the training or inference of a machine learning model (e.g., a classifier), the modality or encoding of the data is used to provide the input to the machine learning model. The present byte-based classifier 305, however, operates on the bytes themselves to identify and infer patterns within the file. Thus, the byte-based classifier can be applied across various modalities and file types and is therefore not limited by modality of the data. Therefore, the byte form of the data may be, but is not limited to, representation of the data in binary.

In some embodiments, processing logic may apply the initial classification model to the remaining unlabeled portion of the file corpus to infer a label for each of the unlabeled files, or to generate an embedding which may be used by another AI model to infer a label for the file. Thus, the entire corpus of data can be labeled via the initial classifier and can thus be used to perform supervised training of another AI model, such as a tree-based model or any other model trained via supervised learning (e.g., via labeled data points). Accordingly, using the representation-agnostic model allows automation of feature extraction (e.g., predicted labels) and allows for model-driven exploration of the representation space, based on a subset that is previously labeled, rather than imposing the rules or labels manually.

As discussed herein, the present disclosure provides an approach that improves computer technology via generalization of label prediction for various data modalities (e.g., shell code from process injection events and operating system executable file binaries), using a byte-based classifier. Embodiments provide for improvements in the technical field of cyber security AI model applications by leveraging the byte-based AI classifier to avoid or limit manual feature engineering. Additionally, embodiments provide for embeddings and enriched data sets that enable for further training and modeling of other AI models.

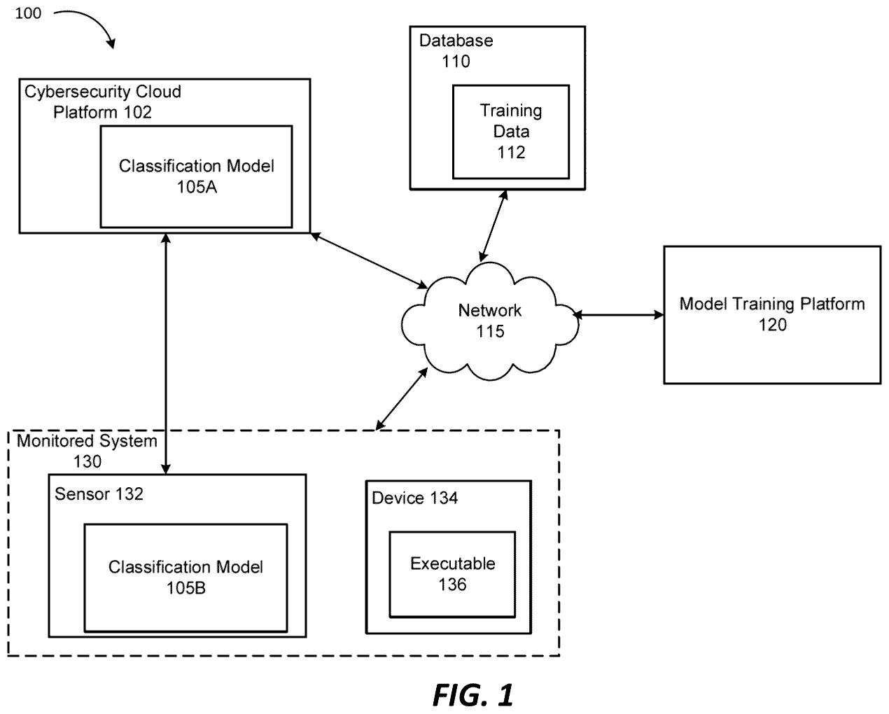

FIG. 1 is a block diagram illustrating a computing system architecture 100 in which embodiments of the present invention may operate. Computing system architecture 100 may include a cybersecurity cloud platform 102, a database 110, a monitored system 130, and a model training platform 120 coupled via a network 115. Network 115 may be a public network (e.g., the internet), a private network (e.g., a local area network (LAN) or wide area network (WAN)), or a combination thereof. In one embodiment, network 108 may include a wired or a wireless infrastructure, which may be provided by one or more wireless communications systems, such as a WiFi™ hotspot connected with the network 115 and/or a wireless carrier system that can be implemented using various data processing equipment, communication towers (e.g., cell towers), etc.

The monitored system 130 may be one or more physical or virtual devices, a cluster of devices, or any other computing system that may be monitored for cybersecurity. For example, the monitored system 130 may be a virtual machine, container, server, a mainframe, a workstation, a personal computer (PC), a mobile phone, a palm-sized computing device, or any other virtual or hardware computing device. The monitored system 130 may include a sensor 132 and a device 143 monitored by the sensor 132. In some examples, the sensor 132 may collect telemetry data of the device 134 and perform cybersecurity functions on the device 134 to prevent cyber attacks on the device 134. The sensor 132 may be hardware, software, or a combination thereof for monitoring the device 143 of monitored system 130. For example, the sensor 132 may be software deployed within an operating system of the device 143 (e.g., to operate as an agent) to collect telemetry data associated with the device 132.

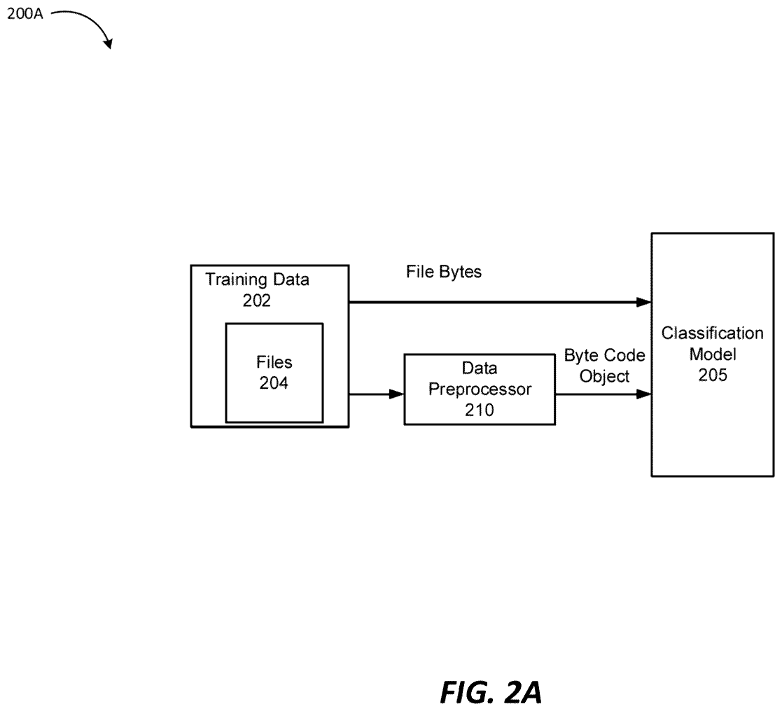

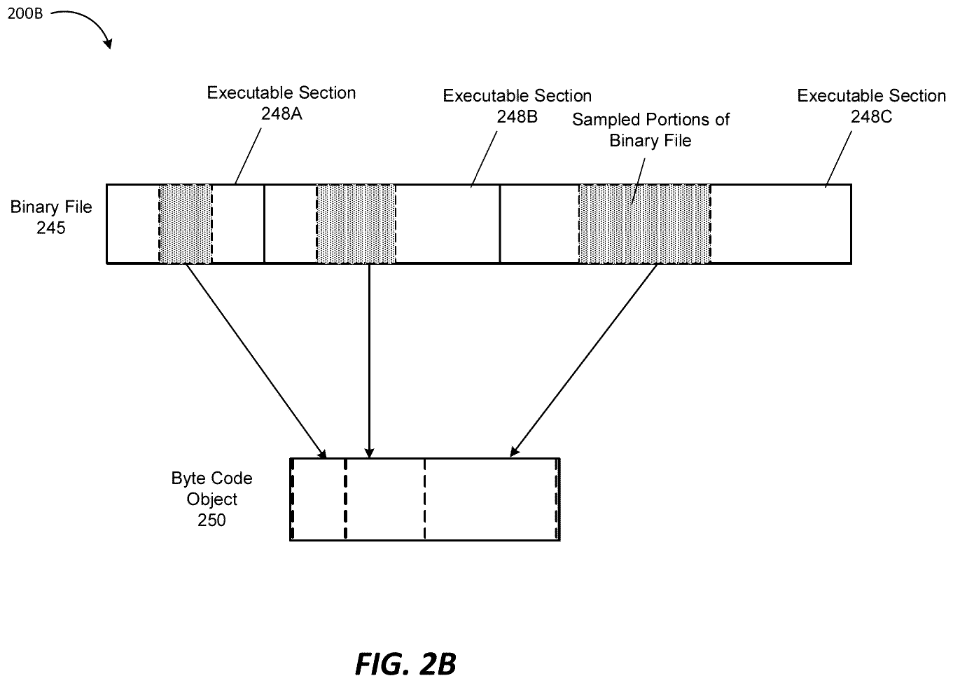

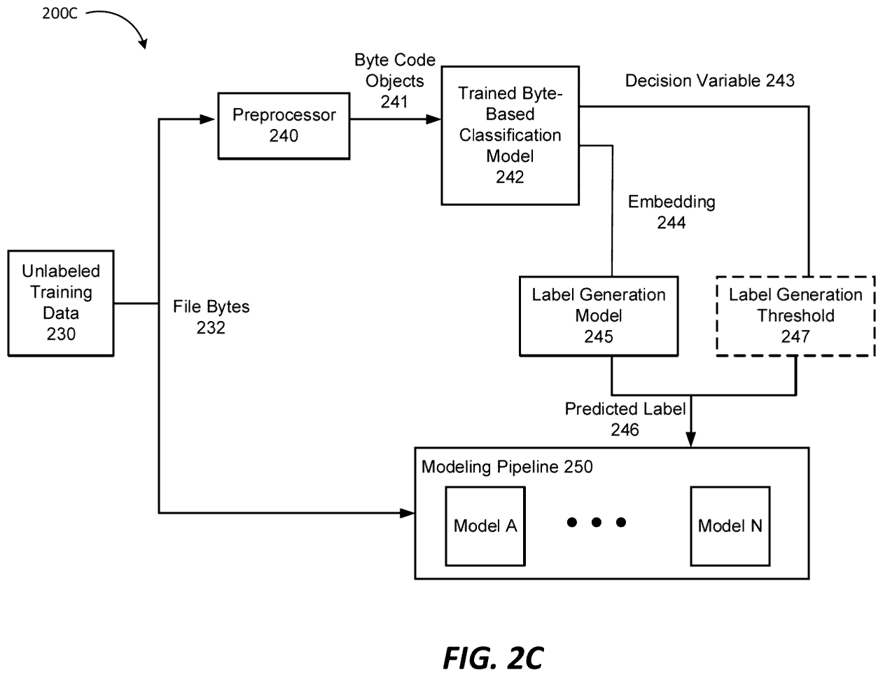

In some examples, the cybersecurity cloud platform 102, the sensor 132, or both the cybersecurity cloud platform 102 and the sensor 132 may execute a classification model (e.g., classification model 105A and 105B, which may be an AI model for classification) for determining whether an executable file (e.g., executable 136) invoked by a process of device 134 should be allowed to be executed or if execution of the executable should be prevented. The sensor 132, for example, may identify executable files prior to execution of the files and apply the classification model 105B, send the files to the cybersecurity cloud platform to apply the classification model 105A, or both. For example, classification model 105A-B may be an AI model trained via a semi-supervised approach using a byte-based classification model via model training platform 120 (e.g., using training data 112 of database 110 which may include an unlabeled or partially labeled corpus of data), as described in more detail with respect to FIGS. 2A-C.

FIG. 2A is a block diagram that illustrates an example system 200A for training a byte-based classification model (e.g., AI model), according to some embodiments. In some embodiments, a classification model 205 is trained via training data 202 including binary files 204. Binary files 204 may include executable files in a binary executable format. In some examples, the raw file bytes of the binary files 204 may be provided as a first input to the classification model 205. In some examples, the file bytes may also be processed by a data preprocessor 210 which may filter out irrelevant sections of the files (e.g., leaving the executable portions that include certain permissions) and randomly sample the remaining portions of the files. The data preprocessor 210 may output one or more byte code objects that include a fixed size of bytes from each binary file, as described with respect to FIG. 2B.

In some embodiments, the classification model 205 may be trained over several training epochs. A training epoch may include a complete iteration over the files 204 of the training data 202. At each epoch, different portions of the binary files may be sampled to generate the byte code objects for each of the files 204. Thus, over several epochs, most or all of the bytes of each file may be sampled and included in a byte code object for training the classification model 205A. In some embodiments, a randomization algorithm may be applied to the sampling of the binary files to provide for coverage of all bytes of each file (e.g., to mathematically ensure that each portion of the binary files and thus all bytes) are utilized in samples for training the classification model 205, thus providing the best possible view of the training data 202. In some examples, the classification model 205 is a transformer-based model. In some examples, the classification model 205 includes a transformer aspect, a convolutional aspect, and a tokenizing aspect that inspects the bytes of the binary files.

FIG. 2B illustrates an example of file byte sampling 200B of a binary file according to some embodiments. In some examples, a binary file 245 that is to be used as training data for a byte-based AI model includes several sections of executable code. In some embodiments, different types of binary files, data, events, etc. may include different executable sections and thus different portions of the binary file 245 may be filtered or selected for use in training depending on the file or data type (e.g., the data modality). During each training epoch, each section of the selected executable code of the file may be sampled in proportion to the size of the section with respect to the total size of the binary file 245 to provide for a fixed size training input from every file. Processing logic (e.g., data preprocessor 210 of FIG. 2A) may then combine the sampled code portions of the binary file 245 together into a byte code object 250. Every byte code object 250 may be of the same fixed size due to the proportional sampling from each section discussed above. As can be seen in FIG. 2B, the binary file 245 includes three executable sections 248A-C, each of which include a different number of bytes. Accordingly, the processing logic may determine a proportional size of each of the executable sections 248A-C. For example, the processing logic may calculate the proportional size of section 248C by dividing the size of section 248C by the total size of the binary file 245, or at least the remaining executable portions of the binary file 245 after filtering out the non-executable portions. The proportion of section 248C may then be multiplied by the fixed size of the byte code object 250 to determine the size of the sampled portion of section 248C. This process may be performed for each executable section (e.g., sections 248A-C).

Accordingly, the classification model (e.g., AI model) may be trained using the binary code objects 250 which are of consistent fixed size (e.g., 100 kb-1 MB) that is less than the overall size of the binary files, reducing computational requirements of processing entire files. In some embodiments, the sampling of the sections of the binary file 245 at each epoch may be systematically changed to ensure full coverage of the binary file 245 for training. Alternatively, the sampling may be completely random and the number of epochs made large enough to provide significant or full coverage of the bytes of the binary file 245 stochastically. Although only three executable sections are depicted in FIG. 2B for ease of illustration, any number of executable sections and any reasonable size of binary code object may be used.

FIG. 2C is a block diagram illustrating a system 200C for training an inference pipeline using labels generated for unlabeled data via a byte-based classification model, according to embodiments of the present disclosure. In some embodiments, a trained byte-based classification model 242, as described above, may be deployed to generate labels (e.g., predicted labels 246) for unlabeled training data 230. In some examples, preprocessor 240 may generate byte code objects 241 from each of the files in the unlabeled training data 230 and provide the byte code objects to the byte-based classification model 242 for analysis. In some embodiments, the preprocessor 240 may be tailored for a particular type of file corpus (e.g., different data types, file types, event types, etc.). For example, each type of file corpus may include different sections, some of which are relevant to classification and others that are not. Accordingly, the preprocessor 240 may identify the relevant sections of code, sample those relevant sections of code as discussed above, and generate the byte code object for application of the byte-based classification model 242. The byte-based model 242 may generate a decision variable 243 including probabilities for various classifications, generate an embedding 244 representing a rich data set, or generate both a decision variable 243 and an embedding 244. Processing logic may compare the decision variable 243 to a label generation threshold 247, and if the threshold is satisfied, generate a label 246 for the corresponding file based on the decision variable 243. Alternatively, the embedding 244 may be input into a label generation model 245 trained to generate a label 246 in response to an embedding received from the byte-based classification model 242. Finally, the generated label 246 may be used in a modeling pipeline 250 for training one or more AI models via the unlabeled training data 230. In other words, the generated label 246 is applied to the corresponding file of the unlabeled training data 230 in order to perform supervised training of one or more models in the modeling pipeline. The models of the modeling pipeline 250 may include tree-based, rule-based, or other various types of AI models (e.g., machine learning models).

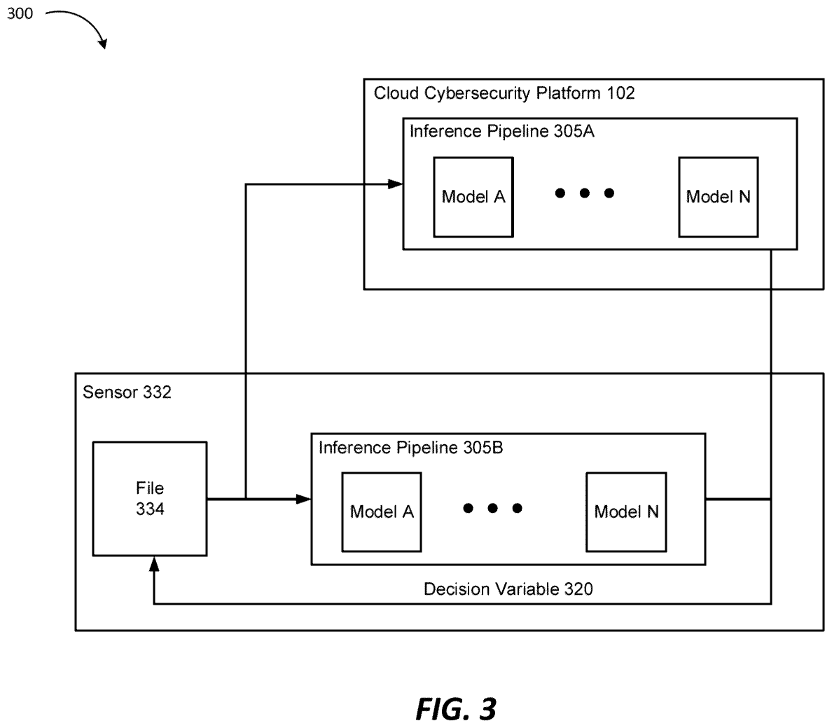

FIG. 3 is a block diagram illustrating an example system 300 for file classification using one or more classification models trained via a semi-supervised training approach using a byte-based classification model, in accordance with embodiments of the present disclosure. As depicted, an inference pipeline 305A-B, as trained in FIG. 2C, may be deployed to a cloud cybersecurity platform 102, a locally deployed sensor 332, or both. Accordingly, the sensor 332 may monitor a corresponding endpoint device (e.g., endpoint device to which sensor 332 is deployed) to determine if a file 334 includes malicious code or content. The sensor 332 may collect data (e.g., metadata) on the file 334 and provide the file to the inference pipeline 305A, 305B, or both. The inference pipelines 305A and 305B may operate similarly and generate the same or similar output (e.g., a decision variable 320 as to whether the file 334 is malicious, compromised, etc.). Accordingly, the sensor 332 may determine, based on the decision variable 320, a security action to perform on the file 334 or a process associated with the file 334, such as preventing execution of the file 334, quarantining the file 334, etc.

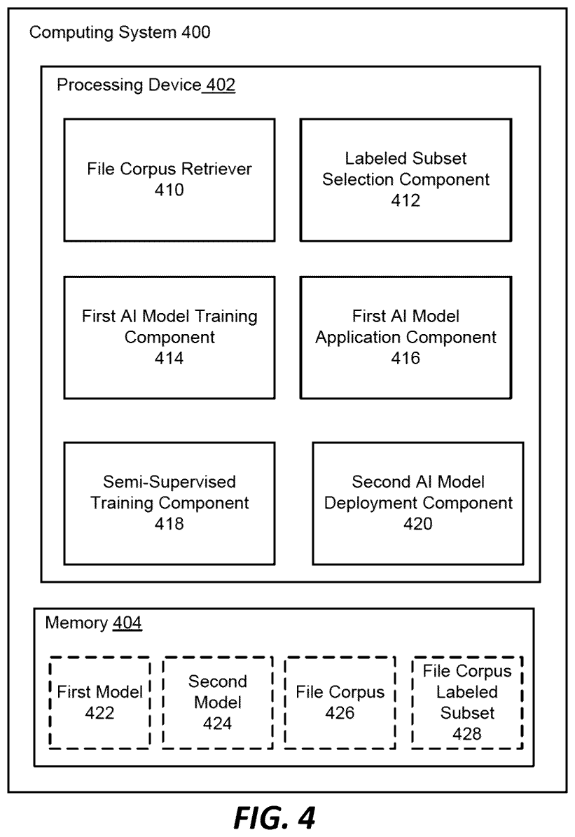

FIG. 4 is a block diagram depicting an example of a computing system 400 for deployment of a classification model via a semi-supervised training approach, according to some embodiments. While various devices, interfaces, and logic with particular functionality are shown, it should be understood that computing system 400 includes any number of devices and/or components, interfaces, and logic for facilitating the functions described herein. For example, the activities of multiple devices may be combined as a single device and implemented on the same processing device (e.g., processing device 402), as additional devices and/or components with additional functionality are included.

The computing system 400 incudes a processing device 402 (e.g., general purpose processor, a PLD, etc.), which may be composed of one or more processors, and a memory 404 (e.g., synchronous dynamic random-access memory (DRAM), read-only memory (ROM)), which may communicate with each other via a bus (not shown).

The processing device 402 may be provided by one or more general-purpose processing devices such as a microprocessor, central processing unit, or the like. In some embodiments, processing device 402 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. In some embodiments, the processing device 402 may include one or more special-purpose processing devices such as an application specific integrated circuit (ASIC), a field programmable gate array (FPGA), a digital signal processor (DSP), network processor, or the like. The processing device 402 may be configured to execute the operations described herein, in accordance with one or more aspects of the present disclosure, for performing the operations and steps discussed herein.

The memory 404 (e.g., Random Access Memory (RAM), Read-Only Memory (ROM), Non-volatile RAM (NVRAM), Flash Memory, hard disk storage, optical media, etc.) of processing device 402 stores data and/or computer instructions/code for facilitating at least some of the various processes described herein. The memory 404 includes tangible, non-transient volatile memory, or non-volatile memory. The memory 404 stores programming logic (e.g., instructions/code) that, when executed by the processing device 402, controls the operations of the computing system 400. In some embodiments, the processing device 402 and the memory 404 form various processing devices and/or circuits described with respect to computing system 400.

The processing device 402 may execute a file corpus retriever 410, a labeled subset selection component 412, a first AI model training component 414, a first AI model application component 416, semi-supervised training component 418, and second AI model deployment component 420. The file corpus retriever 410 may identify and retrieve, or otherwise obtain a file corpus associated with a particular data modality. For example, the file corpus retriever 410 may retrieve all executable binary operating system files collected over a period of time. In some examples, the file corpus retriever 410 may obtain a set of event files or event associated data collected by an endpoint protection system over a period of time. The file corpus retriever 410 may obtain any corpus of data that is unlabeled or partially labeled. The labeled subset selection component 412 may identify labeled data within the file corpus 426. In some embodiments, the labeled subset selection component 412 may select a set of labeled files that are representative of the file types, sizes, and any other characteristics of the file corpus 426 as a whole. Accordingly, training the first AI model using the labeled subset 428 may allow the trained first AI model to infer labels for the unlabeled portions of the file corpus 426.

The first AI model training component 414 may train a byte-based machine learning model using subset of a file corpus 424. The subset of the file corpus may be a labeled subset 428. For example, only a small percentage of the file corpus 426 may be labeled and therefore the labeled subset may include all or most of the labeled data in the file corpus 426. Additionally, the labeled subset 428 may be representative of the corpus 426 as a whole. For example, the subset 428 may include a representation of each of the file types and file sizes in the file corpus 426. In some embodiments, the labeled subset 428 may include manually labeled files to provide a sufficient representation of the file corpus 424.

The first AI model applicant component 416 may apply the first AI model 422 to the unlabeled portions of the file corpus 426 to generate a decision variable, an embedding, or both a decision variable and an embedding. The decision variable may be used to directly infer a label for the corresponding unlabeled data. Alternatively, the embedding may be input to an additional classifier to generate a label for the unlabeled data from the embedding. The semi-supervised training component 418 may train a second model 424, or a plurality of additional models, to infer whether a file is malicious, by applying or assigning the output (e.g., labels) from application of the first model 422 to each of the unlabeled files in the file corpus. Accordingly, the semi-supervised training component 418 may train the second model using the file corpus 426 in a supervised fashion by applying the label generated by the first model 420 to infer labels for the unlabeled portions of the file corpus 426.

In some embodiments, the second model deployment component 420 may deploy the second model, as trained, to an endpoint protection system. The endpoint protection system may further monitor files of an endpoint to identify malicious files using the second model. For example, a sensor of the endpoint may provide files to the second model to classify the files regarding whether the files are malicious, safe, risky, or any other level of cybersecurity classification.

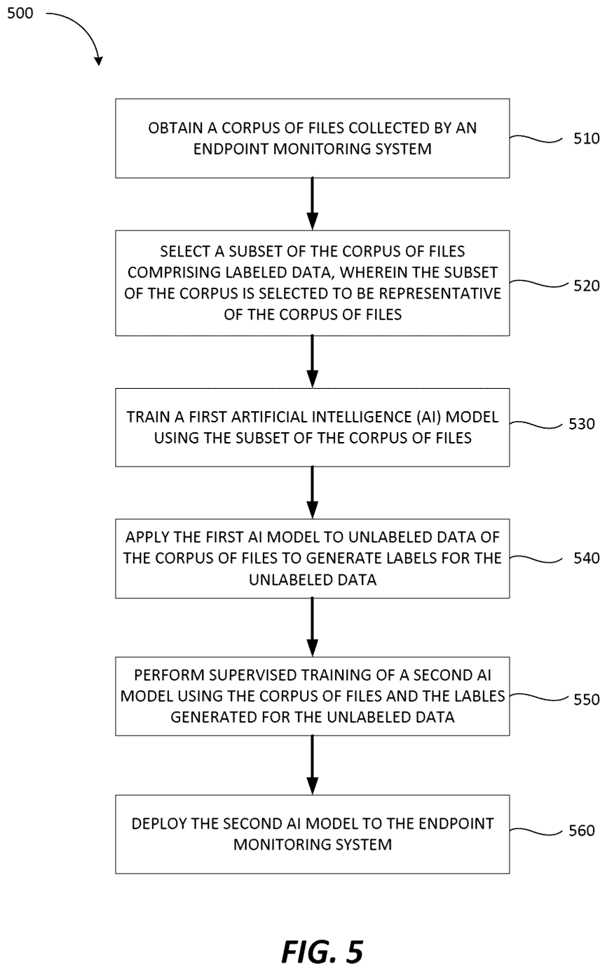

FIG. 5 is a flow diagram of a method 500 of deploying a classification model via a semi-supervised training approach, in accordance with some embodiments of the present disclosure. Method 500 may be performed by processing logic that may include hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, at least a portion of method 500 may be performed by cybersecurity cloud platform 102 or sensor 132 of FIG. 1.

With reference to FIG. 5, method 500 illustrates example functions used by various embodiments. Although specific function blocks (“blocks”) are disclosed in method 500, such blocks are examples. That is, embodiments are well suited to performing various other blocks or variations of the blocks recited in method 500. It is appreciated that the blocks in method 500 may be performed in an order different than presented, and that not all of the blocks in method 500 may be performed.

With reference to FIG. 5, method 500 begins at block 510, where processing logic obtains a corpus of files collected by an endpoint protection system. At block 520, processing logic selects a subset of the corpus of files including labeled data, wherein the subset of the corpus is selected to be representative of the corpus of files. In some embodiments, processing logic identifies labeled data in the corpus of files and selects the subset of the corpus of files to represent characteristics of the corpus of files.

A block 530, processing logic trains a first AI model using the subset of the corpus of files. In some embodiments, the processing logic trains the first AI model with the subset of the corpus of files in byte form. In some embodiments, processing logic randomly samples byte segments of each file of the subset of the corpus of files in byte form and inputs the byte segments of each file of the subset of the corpus of files as training data for the first AI model (e.g., as a byte code object).

In some embodiments, the first AI model (e.g., a transformer-based model or the like) is trained on a large dataset of labeled file or event samples bearing executable byte code, including benign, malicious, obfuscated and non-obfuscated examples. In order to accommodate a large number of file or event types, this model operates in a representation-agnostic way, (e.g., the input data is the pure byte code attached to the specific file or event type in question). Depending on the file or event type, processing logic may perform one or more preprocessing steps such as the filtering of certain file or event sections which, amongst other effects, serve to enhance the efficiency of model training.

At block 540, processing logic applies the first AI model to unlabeled data of the corpus of files to generate labels for the unlabeled data. A version of the first model is used to generate labels for previously unlabeled portions of the file corpus. In some embodiments, the label is produced via thresholding of the decision variable output of the trained first model or based on a rich intermediate layer embedding generated by the trained first model which serves as an input to further modeling. The choice of unlabeled portion can be optimized to be a representative selection of the use cases for inference.

At block 550, processing logic performs supervised training of a second AI model using the corpus of files and the labels generated for the unlabeled data. The portion of the file corpus which now has labels attached to it based on the first AI model is then subjected to a supervised learning approach using a modeling pipeline. This pipeline may include models of various architectures and input data modalities and is trained by optimizing the distance between its prediction and the base learner prediction (i.e., the new label).

At block 560, processing logic deploys the second AI model to the endpoint protection system. Depending on the deployment target of the modeling pipeline, the processing logic (e.g., the sensor) detects the execution of a certain file type or event type and sends its contents to the cloud, or the sensor detects the execution of a certain file type or event type and flags it for classification using a locally running instance of the modeling pipeline. The modeling pipeline may analyze the file or event and retain it, along with associated metadata, for future training. The modeling pipeline outputs a decision variable, which contains predicted probabilities for each possible label. Based on the output of the modeling pipeline and potentially further indicators, the sensor can halt the execution of the process which attempted to execute the file.

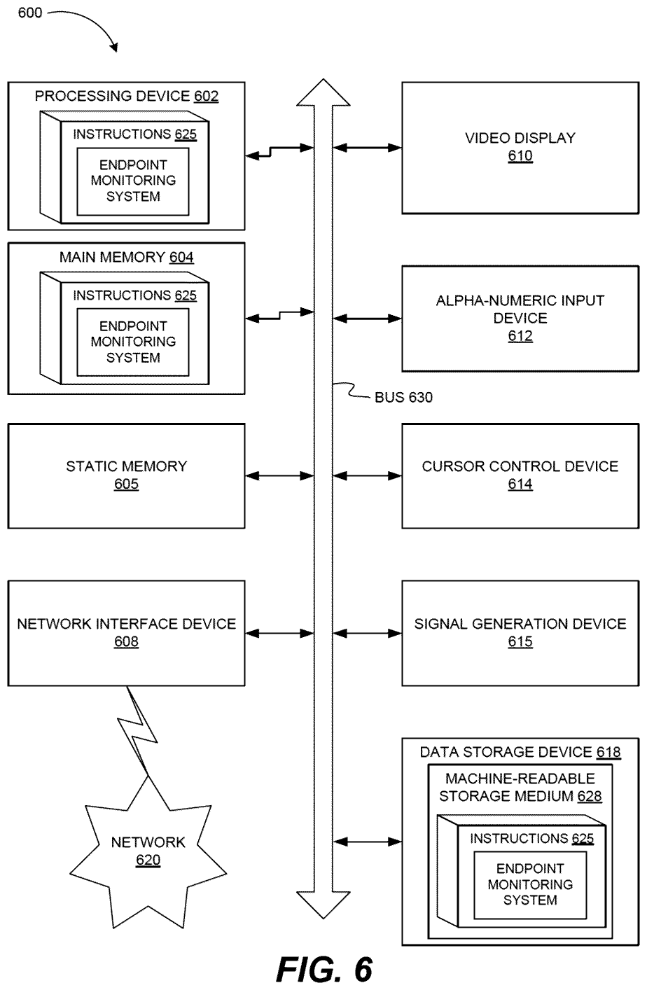

FIG. 6 illustrates a diagrammatic representation of a machine in the example form of a computer system 600 within which a set of instructions, for causing the machine to perform any one or more of the methodologies discussed herein.

In alternative embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, a switch or bridge, a hub, an access point, a network access control device, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In some embodiments, computer system 600 may be representative of a server.

The exemplary computer system 600 includes a processing device 602, a main memory 604 (e.g., read-only memory (ROM), flash memory, dynamic random access memory (DRAM), a static memory 606 (e.g., flash memory, static random access memory (SRAM), etc.), and a data storage device 618 which communicate with each other via a bus 630. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

Computer system 600 may further include a network interface device 608 which may communicate with a network 620. Computer system 600 also may include a video display unit 610 (e.g., a liquid crystal display (LCD) or a cathode ray tube (CRT)), an alphanumeric input device 612 (e.g., a keyboard), a cursor control device 614 (e.g., a mouse) and an acoustic signal generation device 616 (e.g., a speaker). In some embodiments, video display unit 610, alphanumeric input device 612, and cursor control device 614 may be combined into a single component or device (e.g., an LCD touch screen).

Processing device 602 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 602 may also be one or more special-purpose processing devices such as an application specific integrated circuit (ASIC), a field programmable gate array (FPGA), a digital signal processor (DSP), network processor, or the like. The processing device 602 is configured to execute endpoint protection system, for performing the operations and steps discussed herein.

The data storage device 618 may include a machine-readable storage medium 628, on which is stored one or more sets of endpoint monitoring instructions 625 (e.g., software) embodying any one or more of the methodologies of functions described herein. The endpoint protection system may also reside, completely or at least partially, within the main memory 604 or within the processing device 602 during execution thereof by the computer system 600; the main memory 604 and the processing device 602 also constituting machine-readable storage media. The endpoint protection system may further be transmitted or received over a network 620 via the network interface device 608.

The machine-readable storage medium 628 may also be used to store instructions to perform a method for semi-supervised AI model classifier training using a byte-based classifier, as described herein. While the machine-readable storage medium 628 is shown in an exemplary embodiment to be a single medium, the term “machine-readable storage medium” should be taken to include a single medium or multiple media (e.g., a centralized or distributed database, or associated caches and servers) that store the one or more sets of instructions. A machine-readable medium includes any mechanism for storing information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; or another type of medium suitable for storing electronic instructions.

Unless specifically stated otherwise, terms such as “deploying,” “monitoring,” “analyzing,” “determining” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may comprise a general-purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a,” “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. § 112 (f) for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the present disclosure to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the present disclosure is not to be limited to the details given herein, but may be modified within the scope and equivalents of the appended claims.

What is claimed is:

1. A method comprising:
obtaining a corpus of files collected by an endpoint protection system;
selecting a subset of the corpus of files comprising labeled files, wherein the subset of the corpus is representative of the corpus of files;
training a first artificial intelligence (AI) model, using the subset of the corpus of files in byte form, to infer labels for unlabeled data;
applying the first AI model to unlabeled files of the corpus of files in byte form to generate labels for the unlabeled files;
performing, by a processing device, supervised training of a second AI model using the corpus of files and the labels generated for the unlabeled data; and
deploying the second AI model to the endpoint protection system.

2. The method of claim 1, wherein the corpus of files is associated with at least one of a file type or event type.

3. The method of claim 1, wherein selecting the subset of the corpus of files comprises:
identifying a plurality of files in the corpus of files that are labeled; and
selecting the subset of the corpus of files, from the identified plurality files that are labeled, to represent characteristics of the corpus of files.

4. The method of claim 3, wherein selecting the subset of the corpus of files further comprises:
determining that the plurality of files in the corpus that are labeled is insufficient to train the first AI model; and
labeling additional files in the corpus of files to produce a sufficient subset of the corpus of files that are labeled.

5. The method of claim 4, wherein training the first AI model further comprises:
randomly sampling byte segments of each file of the subset of the corpus of files in byte form; and
inputting the byte segments of each file of the subset of the corpus of files as training data for the first AI model.

6. The method of claim 1, wherein applying the first AI model to unlabeled files of the corpus of files to generate labels for the unlabeled files comprises:
for each file in the unlabeled files of the corpus of files:
generating, by the first AI model, a decision variable for the file based on the file in byte form;
determining whether the decision variable satisfies a label generation threshold; and
in response to the decision variable satisfying the label generation threshold, generating a first label for the file based on the decision variable.

7. The method of claim 6, further comprising:
for each file in the unlabeled files of the corpus of files:
generating an embedding based on the file, wherein the embedding comprises a plurality of data points for the file;
applying a third AI model to the embedding to generate a second label for the file; and
in response to determining that the decision variable generated by the first AI model does not satisfy the label generation threshold, assigning the second label to the file.

8. A system comprising:
a memory; and
a processing device, operatively coupled to the memory, to:
obtain a corpus of files collected by an endpoint protection system;
select a subset of the corpus of files comprising labeled files, wherein the subset of the corpus is representative of the corpus of files;
train a first artificial intelligence (AI) model, using the subset of the corpus of files in byte form, to infer labels for unlabeled data;
apply the first AI model to unlabeled files of the corpus of files in byte form to generate labels for the unlabeled files;
perform supervised training of a second AI model using the corpus of files and the labels generated for the unlabeled files; and
deploy the second AI model to the endpoint protection system.

9. The system of claim 8, wherein the corpus of files is associated with at least one of a file type or event type.

10. The system of claim 8, wherein to select the subset of the corpus of file, the processing device is to:
identify a plurality of files in the corpus of files that are labeled; and
select the subset of the corpus of files, from the identified plurality files that are labeled, to represent characteristics of the corpus of files.

11. The system of claim 10, wherein to select the subset of the corpus of files the processing device is to:
determine that the plurality of files in the corpus that are labeled is insufficient to train the first AI model; and
label additional files in the corpus of files to produce a sufficient subset of the corpus of files that are labeled.

12. The system of claim 11, wherein to train the first AI model, the processing device is further to:
randomly sample byte segments of each file of the subset of the corpus of files in byte form; and
input the byte segments of each file of the subset of the corpus of files as training data for the first AI model.

13. The system of claim 8, wherein to apply the first AI model to unlabeled files of the corpus of files to generate labels for the unlabeled files, the processing device is to:
for each file in the unlabeled files of the corpus of files:
generate, by the first AI model, a decision variable for the file based on the file in byte form;
determine whether the decision variable satisfies a label generation threshold; and
in response to the decision variable satisfying the label generation threshold, generate a first label for the file based on the decision variable.

14. The system of claim 13, wherein to apply the first AI model to unlabeled data of the corpus of files to generate labels for the unlabeled data, the processing device is to:
for each file in the unlabeled files of the corpus of files:
generate an embedding based on the file, wherein the embedding comprises a plurality of data points for the file;
apply a third AI model to the embedding to generate a second label for the file; and
in response to determining that the decision variable generated by the first AI model does not satisfy the label generation threshold, assign the second label to the file.

15. A non-transitory computer readable medium having instructions encoded thereon that, when executed by a processing device, cause the processing device to:
obtain a corpus of files collected by an endpoint protection system;
select a subset of the corpus of files comprising labeled files, wherein the subset of the corpus is representative of the corpus of files;
train a first artificial intelligence (AI) model, using the subset of the corpus of files, to infer labels for unlabeled data;
apply the first AI model to unlabeled files of the corpus of files to generate labels for the unlabeled files;
perform, by the processing device, supervised training of a second AI model using the corpus of files and the labels generated for the unlabeled files; and
deploy the second AI model to the endpoint protection system.

16. The non-transitory computer readable medium of claim 15, wherein to select the subset of the corpus of file, the processing device is to:
identify a plurality of files in the corpus of files that are labeled; and
select the subset of the corpus of files, from the identified plurality files that are labeled, to represent characteristics of the corpus of files.

17. The non-transitory computer readable medium of claim 16, wherein to select the subset of the corpus of files the processing device is to:
determine that the plurality of files in the corpus that are labeled is insufficient to train the first AI model; and
label additional files in the corpus of files to produce a sufficient subset of the corpus of files that are labeled.

18. The non-transitory computer readable medium of claim 17, wherein to train the first AI model, the processing device is further to:
randomly sample byte segments of each file of the subset of the corpus of files in byte form; and
input the byte segments of each file of the subset of the corpus of files as training data for the first AI model.

19. The non-transitory computer readable medium of claim 15, wherein to apply the first AI model to unlabeled data of the corpus of files to generate labels for the unlabeled data, the processing device is to:
for each file in the unlabeled data of the corpus of files:
generate, by the first AI model, a decision variable for the file based on the file in byte form;
determine whether the decision variable satisfies a label generation threshold; and
in response to the decision variable satisfying the label generation threshold, generate a first label for the file based on the decision variable.

20. The non-transitory computer readable medium of claim 19, wherein to apply the first AI model to unlabeled data of the corpus of files to generate labels for the unlabeled data, the processing device is to:
for each file in the unlabeled data of the corpus of files:
generate an embedding based on the file, wherein the embedding comprises a plurality of data points for the file;
apply a third AI model to the embedding to generate a second label for the file; and
in response to determining that the decision variable generated by the first AI model does not satisfy the label generation threshold, assign the second label to the file.
